(19) United States
(12) Patent Application Publication
(10) Pub. No.: US 2016/0007790 A1
(43) Pub. Date: Jan. 14, 2016

(54) VESSEL FOR TRANSFERRING THERMAL ENERGY TO A CONTAINED FLUID

(71) Applicants: Richard J. Schoofs, Moraga, CA (US); Gregory R. Schoofs, Moraga, CA (US)

(72) Inventors: Richard J. Schoofs, Moraga, CA (US); Gregory R. Schoofs, Moraga, CA (US)

(21) Appl. No.: 14/331,119

(22) Filed: Jul. 14, 2014

(51) Int. Cl. A47J 27/21; A47J 36/02

(52) U.S. Cl. CPC A47J 27/21166; A47J 36/02

(57) ABSTRACT

An article of manufacture including a wall portion having a wall inner surface and a wall outer surface. The article of manufacture also includes a base portion having a base inner surface and a base outer surface. At least a portion of the wall portion and the base portion form a vessel to retain a fluid therein. At least one of a shaped portion of the base outer surface is shaped to have substantially more surface area in thermal contact with a heating source than a flat base outer surface so as to allow the retained fluid to receive additional heat from the heating source, or, a shaped portion of the base inner surface is shaped to have substantially more surface area in thermal contact with the substance than a flat base inner surface so as to transfer additional heat from the heat source to the retained fluid.

### BACKGROUND

Vessels are used to contain substances such as fluids. A vessel is any hollow container including, for example, a container manufactured to hold a fluid (e.g., water, liquid, substance, or liquid/solid mixtures) and to facilitate the transfer of thermal energy to the substance (e.g., fluid) contained within. Examples of such vessels include pots, kettles, and the like.

Such vessels in the prior art such as pans or skillets typically include a flat bottom or a bottom that is indented around a perimeter of the bottom. Even with such an indentation, the bottom of such vessels is primarily flat. The bottom of the vessel is generally set against a heat source (e.g., flame or heating element). The heat source transfers thermal energy through the flat bottom of the vessel and into the fluid therein. There may be design elements or reinforcement elements on the vessel or the bottom of the vessel.

Essentially, the same vessel has been used worldwide. Differences in vessels of the same type are generally cosmetic, based on durability, based on ergonomics, or different choices of fabrication material.

### SUMMARY

An article of manufacture configured to transfer thermal energy to a contained substance such as a liquid or liquid/solid mixture. In some embodiments, the article of manufacture includes a wall portion having a wall inner surface and a wall outer surface; a base portion having a base inner surface and a base outer surface, at least a portion of the wall portion and the base portion forming a vessel to retain fluid therein, at least a heating surface portion of the base outer surface positioned to receive heat from a heating source, and at least one of: a shaped portion of the base outer surface being shaped to have substantially more surface area in thermal contact with the heating source than a flat base outer surface to receive additional heat from the heating source, or a shaped portion of the base inner surface shaped to have substantially more surface area in thermal contact with the fluid than a flat base inner surface to transfer additional heat from the heat source to the fluid.

In some embodiments, a shaped surface is corrugated to include a plurality of ridges and furrows. In some embodiments the ridges and furrows are shaped as a sinusoidal wave. In some embodiments, the ridges and furrows are shaped as a square wave. The ridges and furrows causing a surface area of the shaped surface to be substantially increased.

In some embodiments, a shaped surface includes a plurality of protrusions and/or indentations. In some embodiments the protrusions are shaped and positioned as a sinusoidal wave. In some embodiments the plurality of protrusions are shaped and positioned as a square wave. The protrusions may cause a surface area of the shaped surface to be substantially increased.

In various embodiments, the shaped portion of the base outer surface is shaped to have 1.2 or more times the surface area than the flat base outer surface. The shaped portion of the base inner surface may be shaped to have 1.2 or more times the surface area than the flat base inner surface.

These and other advantages will become apparent to those skilled in the relevant art upon a reading of the following descriptions and a study of the several examples shown in the drawings. The drawings are included for illustrative purposes and are not intended to limit possible or potential shapes, patterns, or locations of protrusions and/or indentations.

### BRIEF DESCRIPTION OF THE DRAWINGS

FIG. 1 depicts a perspective view of an example of a kettle for transferring thermal energy to a contained substance.

FIG. 2A is a planar view of an example kettle bottom surface with a cavity defined between an edge of the base of the kettle and a thick metal encapsulated base in the prior art.

FIG. 2B is a cross section view of an example kettle bottom surface with a cavity defined between an edge of the base of the kettle and a thick metal encapsulated base in the prior art.

FIG. 2C includes dimensions for the cross section view of FIG. 2B.

FIG. 3 is a cross sectional view of a vessel (e.g., a portion of the kettle) in some embodiments.

FIG. 4 is a planar view of an example shaped surface that is corrugated according to an example pattern.

FIG. 5 is a planar view of an example shaped surface that is corrugated according to another example pattern.

FIG. 6 is a planar view of an example shaped surface that is corrugated according to another example pattern.

FIG. 7A is a cross-sectional view of a shaped surface that includes ridges and furrows shaped according to a sinusoidal wave.

FIG. 7B is a cross-sectional view of a shaped surface that is corrugated with ridges and furrows shaped according to a square wave.

FIG. 8 is a planar view of a shaped surface that is corrugated according to another example pattern.

FIG. 9 is a planar view of a shaped surface that is corrugated according to another example pattern.

FIG. 10 is a planar view of a shaped surface with a plurality of protrusions according to a protrusion pattern.

FIG. 11 is a planar view of a shaped surface with a plurality or protrusions according to another protrusion pattern.

FIG. 12 is a planar view of a shaped surface with a plurality or protrusions according to another protrusion pattern.

FIG. 13 is a planar view of a shaped surface with a plurality or protrusions according to another protrusion pattern.

FIG. 14A is a cross-sectional view of a shaped surface with protrusions shaped as a sinusoidal wave.

FIG. 14B is a cross-sectional view of a shaped surface with protrusions shaped as a square wave.

FIG. 15A depicts interlocking elbow shaped surfaces in some embodiments.

FIG. 15B depicts conical shaped surfaces in some embodiments.

FIG. 15C depicts conical shaped indentations in some embodiments.

FIG. 15D depicts triangular shaped surfaces in some embodiments.

FIG. 15E depicts triangular shaped indentations in some embodiments.

FIG. 15F depicts dimple shaped indentation in some embodiments.

FIG. 15G depicts dimple shaped surfaces in some embodiments.

### DETAILED DESCRIPTION

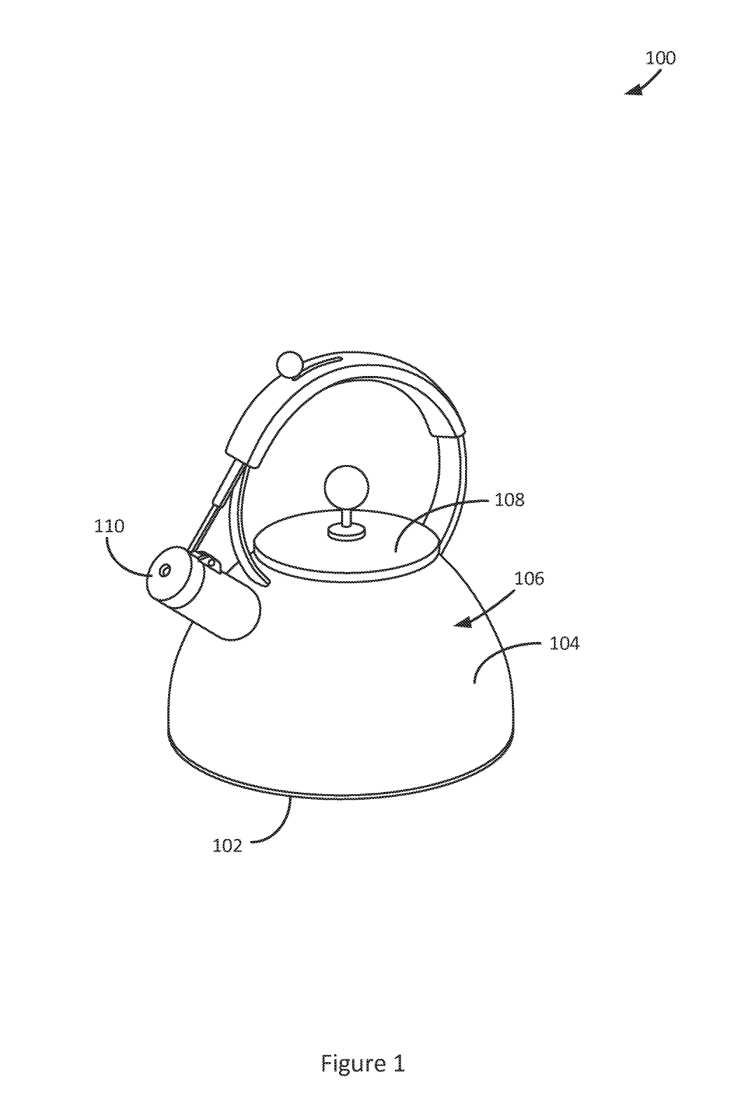

FIG. 1 depicts a perspective view of an example of a kettle 100 for transferring thermal energy to a contained fluid such as water, a liquid, a substance, or a liquid/solid mixture (e.g., soup). While the kettle 100 is provided as one example, in other embodiments any container (e.g., a vessel) may be utilized such as, but not limited to, a pot, pan, or any other container which may hold a substance. In some embodiments, various embodiments described herein may be utilized with a cooking implement. For example, a surface area of a cooking implement may be substantially increased thereby allowing for thermal energy to be absorbed and/or transferred at a substantially increased rate.

The kettle 100 includes a base portion 102 and a wall portion 104. The base portion 102 and the wall portion 104 may be formed from a single piece of material or, alternately, by multiple pieces of material. The kettle may be formed in any number of ways such as, for example, welding the base portion 102 to the wall portion 104. The base portion 102 and the wall portion 104 may be comprised of one or a plurality of applicable materials that may assist in containing the substance and/or transferring thermal energy from the outside of the kettle 100 to the inside of the kettle 100.

The kettle 100 may comprise any kind of material. For example, the base portion 102 and/or the wall portion 104 may comprise material such as, but not limited to, steel, copper, ceramic(s), and/or the like. The base portion 102 and/or the wall portion 104 may comprise an alloy or any combination of materials. In some embodiments, the base portion 102 and the wall portion 104 may include a sandwich structure of various layers of materials. For example, the base portion 102 and/or the wall portion 104 may be clad and include a layer of copper, aluminum, or other metal(s) sandwiched between layers of steel.

The base portion 102 and the wall portion 104 may combine to create a vessel 106 that functions to contain a volume of a substance. In various embodiments, the kettle 100 may be referred to as a vessel or, in some embodiments, the kettle may comprise a vessel. The vessel 106 is a portion of the kettle 100 that may contain or hold the substance. In various embodiments, the kettle 100 receives heat from an external heat source and transfers heat through the base 102 to the contained substance.

In various embodiments, the base portion 102, and potentially, the wall portion 104 are in thermal contact with the substance (e.g., fluid) contained within the kettle 100. In some embodiments, the thermal contact enables thermal energy to transfer from or through the base portion 102 and/or the wall portion 104 to the contained substance (e.g., held by the container 106). For example, the substance is in thermal contact with the base portion 102 because the substance within the kettle 100 is in physical contact with the base portion 102 and/or wall portion 104. In transferring thermal energy to the contained substance, the base portion 102 and/or the wall portion 104 may, in some embodiments, absorb thermal energy from a thermal energy source (e.g., fire, heating element, or the like such as, but not limited to, electric, ceramic, halogen, gas, or induction heating). Further in transferring thermal energy to a contained substance, the base portion 102 and/or the wall portion 104 can transfer energy absorbed from the thermal energy source to the contained substance. Those skilled in the art will appreciate that the thermal energy source may be external to the kettle 100 (e.g., a stove or fire) or be internal to the kettle 100 (e.g., an electric kettle 100 or any other electric container).

In an example of operation, the base portion 102 and/or the wall portion 104 may absorb thermal energy from many different types of thermal energy sources. In various embodiments, the base portion 102 and/or wall portion 104 may receive thermal energy from, but not limited to, conduction, convection, induction, or radiation heating. Additionally, the base portion 102 and/or the wall portion 104 can transfer absorbed thermal energy to the contained substance and/or facilitate convection in the contained substance.

The kettle 100 includes a receiving aperture 108. The receiving aperture 108 is an opening through which the substance (e.g., fluid) may be passed out of and/or into the vessel 106. In some embodiments, once the substance is contained within the vessel 106, thermal energy can be transferred from the external heating source, through the base portion 102 and/or the wall portion 104.

The kettle 100 includes a dispensing aperture 110. The dispensing aperture 110 is an opening through which the substance may be passed out from the vessel 106. The dispensing aperture 110 may be shaped to allow for the pouring of the substance. In some embodiments, the dispensing aperture 110 passes heated fluid after a desired amount of thermal energy is transferred to the fluid. For example, the dispensing aperture 110 may be used to pass a contained liquid out of the vessel 106 after enough thermal energy is transferred to the liquid contained within the vessel 106 to cause the liquid to boil.

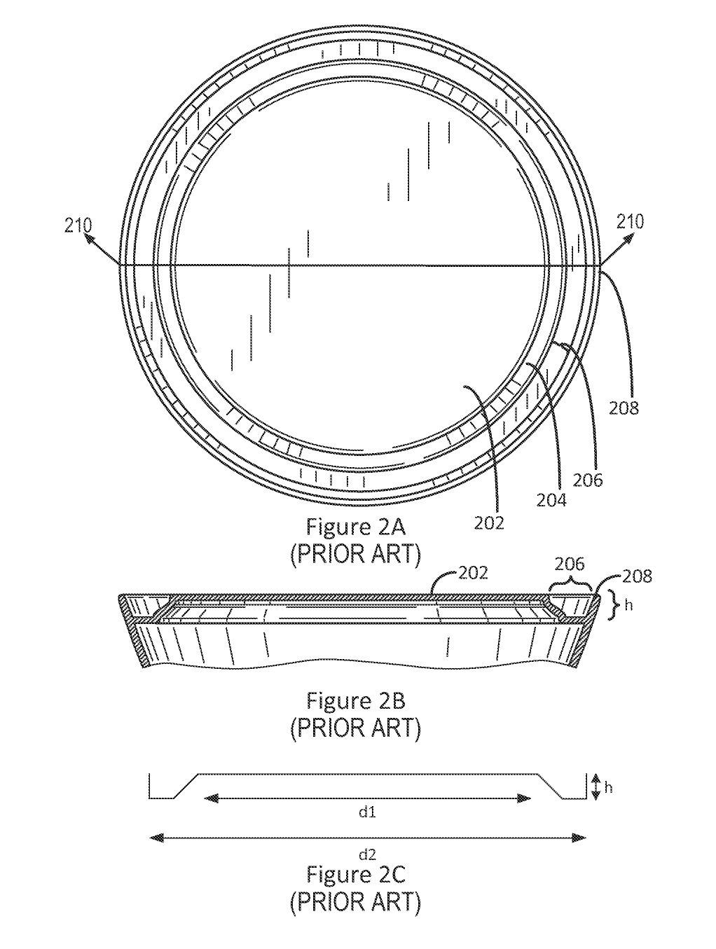

FIG. 2A is a planar view of an example kettle bottom surface with a cavity defined between an edge 208 of the base of the kettle and a thick metal encapsulated base 202 in the prior art. In the prior art, some kettles include a thick aluminum encapsulated base (or other encapsulated metal) for uniform or even heating. In this example, the thick metal encapsulated base 202 is flat and is a major portion (e.g., a predominant portion) of the bottom of the kettle. An encapsulated base edge 204 and edge 208 of the kettle may define a cavity 206 along the rim of the base of the kettle. A diameter 210 is a diameter of the base of the kettle.

The edge 208 may allow for the thick metal encapsulated base 202 to be coupled to the bottom of the kettle. The edge 208 and cavity 206 may also capture the edge of stove flames to entrap heat. Although there is an increase in surface area, the increase in heat transfer is nominal because the increase in the surface area is nominal.

FIG. 2B is a cross section view of an example kettle bottom surface with a cavity 206 defined between an edge 208 of the kettle and a thick metal encapsulated base 202 in the prior art. In this cross-sectional view, the cavity 206 is shown between the edge of the kettle 208 and the encapsulated base 202. As can be seen, there is not a substantial or significant increase in surface area of the bottom when compared to a kettle with a flat bottom.

FIG. 2C includes dimensions for the cross section view of FIG. 2B. Here, dimension “d1” represents the diameter of the thick metal encapsulated base 202. Dimension “d2” represents the diameter of the base of the kettle (e.g., diameter 210). Dimension “h” represents the distance that the thick metal encapsulated base 202 extends perpendicularly from the base of the periphery of the kettle. Given these dimensions, the increase in surface area for the kettle bottom surface in FIG. 2C relative to a kettle with a flat bottom surface is:

Δarea=(area of this example kettle bottom surface)−(area if the kettle bottom surface was flat)

With the dimensions shown in FIG. 2C:

$$Δ area = ( π ) ( h ) ( d 2 + ( ( \frac{\sqrt{2}}{2} ) - 1 ) ( d 1 ) + ( \sqrt{2} - 1 ) ( h ) )$$

The percentage increase in the surface area for this example kettle bottom surface relative to the surface area if the kettle bottom surface was flat equals:

(100%)(Δarea)/(area if the kettle bottom surface was flat)

For example, using the dimensions as labeled in FIG. 2C, a kettle with approximate dimensions of d1=7 inch, d2=9 inch, and h=¼ inch, will have a percentage increase in the surface area of approximately ten percent (e.g., 10%) relative to a kettle with a flat bottom. This percentage increase in the surface area (of this kettle in the prior art) does not significantly or appreciably increase the surface area (relative to a flat bottom surface) such that the thermal transfer would also significantly or appreciably increase.

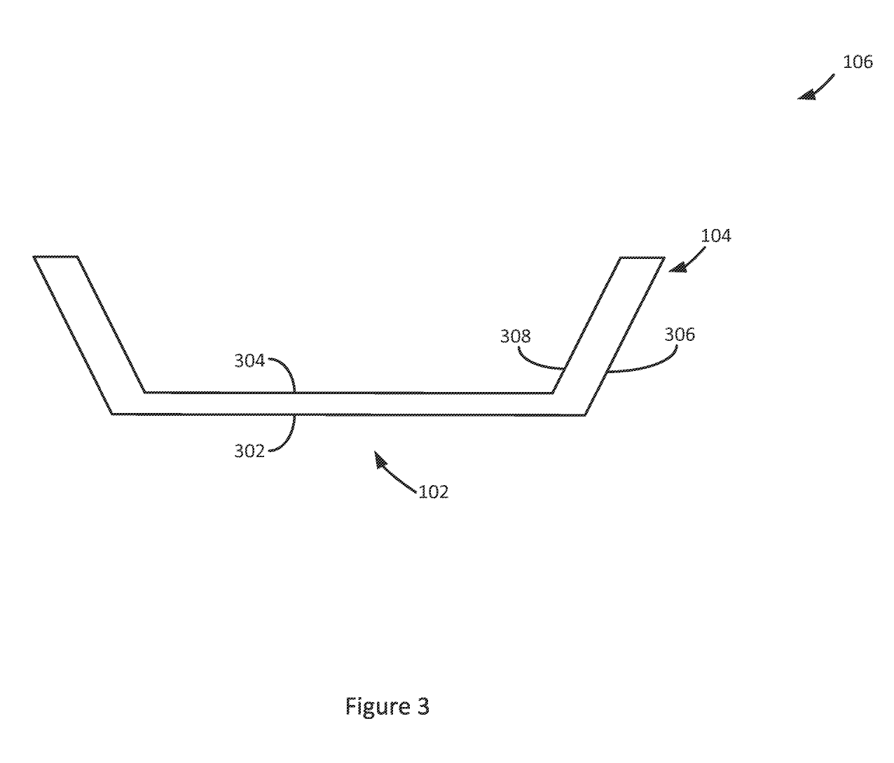

FIG. 3 is a cross sectional view of a vessel 106 (e.g., a portion of the kettle 100) in some embodiments. The vessel 106 is formed by a base portion 102 and a wall portion 104. The base portion 102 includes a base outer surface 302 and a base inner surface 304. The base outer surface 302 is the surface opposite of the base inner surface 304.

In various embodiments, the base outer surface 302 is the surface of the base portion 102 through which thermal energy is received from the thermal energy source. The base outer surface 302 may include a heating surface portion that receives and absorbs heat from the thermal energy source. The base inner surface 304 is the surface of the base portion 102 through which absorbed thermal energy may be transferred to the contained substance (e.g., a fluid contained or held within the vessel 106). Thus, the base portion 102 may be thermally coupled to the substance contained within the vessel 106 through the base inner surface 304. In various embodiments, the base inner surface 304 may physically contact at least some of the substance contained within the vessel 106, and thereby be thermally coupled to the substance contained within the vessel 106.

In some embodiments, at least one of the base outer surface 302 and/or the base inner surface 304 includes a shaped portion. A shaped portion of the base outer surface 302 or the base inner surface 304 is shaped such that there is substantially more surface area when compared to a flat surface. A shaped portion of the base outer surface 302 may include, for example, raised rectangular ridges, raised sinusoidal ridges, raised rectangular ridges, posts, raised portions, protrusions, indentations, or the like of any size or shape. The shaped portion may include raised portions of a surface, depressed portions in the surface, or a combination of raised portions and depressed portions of the surface. Substantially more surface area may, for example, include double a surface area when compared to the surface area of a flat surface. Examples of shaped portions with substantially increased surface area (in comparison with a flat surface), are described herein. In various embodiments, only a portion of the base outer surface 302 and/or the base inner surface 304 includes shaped portions.

The wall portion 104 includes a wall outer surface 306 and a wall inner surface 308. The wall outer surface 306 is opposite the wall inner surface 308. In some embodiments, all or a portion of the wall outer surface 306 may receive thermal energy from the thermal energy source. A portion of the wall inner surface 308 may transfer thermal energy from the wall outer surface 306 to the contained fluid. Thus, a portion of the wall portion 104 may be thermally coupled to the contained fluid. In various embodiments, the wall inner surface 308 may physically contact the fluid contained within the vessel 106.

In some embodiments, at least a portion of the wall outer surface 306 and/or at least a portion of the wall inner surface 308 include a shaped portion. A shaped portion of the wall outer surface 306 or the wall inner surface 308 is shaped such that the shaped portion has substantially more surface area than if the shaped portion of the corresponding wall outer surface 306 or wall inner surface 308 was flat.

The shaped portion of the wall outer surface 306 and/or the shaped portion of the wall inner surface 308 may include, for example, raised sinusoidal ridges, raised rectangular ridges, indented sinusoidal furrows, indented rectangular ridges, posts raised portions, depressed portions, protrusions, indentations, or the like of any size or shape. The shaped portion may include raised portions of a surface, depressions in the surface, or a combination of raised portions and depressed portions (e.g., a combination of protrusions and indentions) of the surface. Examples of shaped portions with substantially increased surface area (in comparison with a flat surface), are described herein. In various embodiments, only a portion or the entire wall outer surface 306 and/or at least a portion of the wall inner surface 308 includes a shaped portion.

A base outer surface 302 and/or a wall outer surface 306 with substantially more surface area than a flat corresponding portion will increase the rate at which thermal energy is transferred to a substance contained within the vessel 106 (e.g., substantially increased). For example, the rate that thermal energy is transferred to the volume of substance may be directly proportional to the surface area of the volume of fluid in thermal contact with the heated surface(s) (e.g., wall inner surface 308 and/or base inner surface 304). Increasing the surface area of the base inner surface 304 of the base portion 102, and/or the wall inner surface 308 (e.g., with protrusions, ridges, fins, furrows, indentations, and/or the like) increases the surface area of contact between a contained substance in the vessel 106 and at least a portion of the base inner surface 304 and/or at least a portion of the wall inner surface 308. Due to the (e.g., substantially) increased surface area between the substance and the base inner surface 304 and/or the wall inner surface 308, the rate of heat transfer from heat absorbed by the vessel 106 (e.g., from a heat source via the base outer surface 302) may be (e.g., substantially) increased.

Similarly, increasing the surface area of the base outer surface 302 of the base portion 102, and/or the wall outer surface 306 (e.g., with protrusions, ridges, fins, indentions, and/or the like of any size or shape) may increase the surface area of contact between the thermal energy provided by the heat source and at least a portion of the base outer surface 302 of the base portion 102, and/or the wall outer surface 306. Due to the (e.g., substantially) increased surface area between the thermal energy of the heat source and the base outer surface 302 and/or the wall outer surface 306, the rate of heat transfer from the thermal energy source to the vessel 106 (e.g., from the heat source) may be (e.g., substantially) increased.

Increasing the amount of thermal energy that is absorbed by at least a portion of the base portion 102 and/or at least a portion of the wall portion 104 may increase the thermal difference between the base portion 102 and/or the wall portion 104 and a substance contained within the vessel 106. Increasing the thermal difference between at least a portion of the base portion 102 and/or at least a portion of the wall portion and a substance contained within the vessel 106 may lead to an increased rate at which thermal energy is transferred from the base portion 102 and/or the wall portion 104 to the substance. As a result of increasing the rate at which thermal energy is transferred from the base portion 102 and/or the wall portion 104 to the substance contained within the vessel 106, more thermal energy is transferred to the substance during a specific (e.g., limited) amount of time. In one example, a fluid may boil faster as a result of the increased surface area(s) of the base potion 102 and wall portion 104.

In some embodiments, in configuring a portion of a base inner surface 304 and/or a wall inner surface 308 to be shaped to have more surface area than a corresponding portion of the surface that is flat, a greater amount of thermal energy is transferred from a heat source to a substance contained within the vessel 106. Increasing the surface area of the base inner surface 304 and/or the wall inner surface 308 may increase the amount of surface area that is in thermal contact with a substance contained within the vessel 106. As a result of increasing the amount of surface area that is in thermal contact with a substance contained within the vessel 106 and/or the heat source, an increased amount of thermal energy may be absorbed by, or otherwise transferred to, the substance.

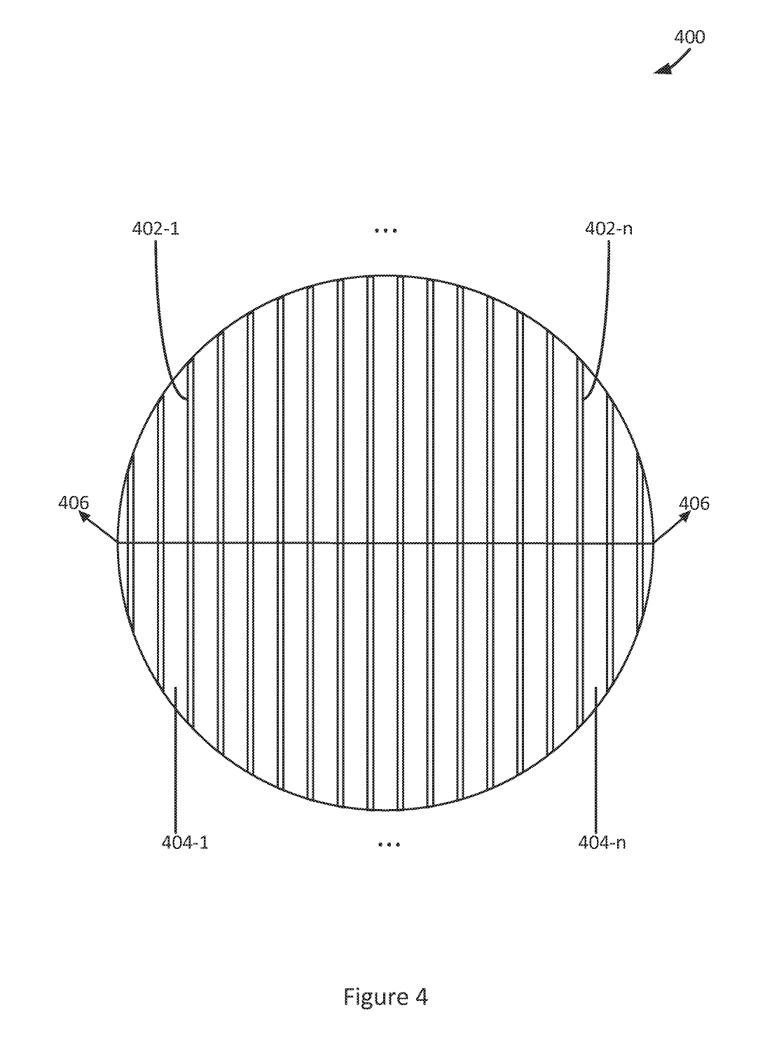

Although FIGS. 4-14 depict patterns of protrusions and indentions (e.g., ridges and furrows), the pattern of protrusions and indentions may not, or need not, be uniform. For example, a shaped surface may comprise a random assortment of any shapes (e.g., a random assortment of protrusions and/or indentions) to increase surface area. In one example, the random assortment increases the surface area by at least 1.2 times over the surface area of a flat surface. All or a part of a surface (e.g., base outer surface 302, base inner surface 304, wall outer surface 306, or wall inner surface 308) may comprise patterns, random assortments, or a combination of patterns and random assortment of shapes.

Further, although FIGS. 4-14 depict patterns of protrusions and indentions, the protrusions and/or indentions (e.g., ridges, furrows, corrugations, or the like) may include any number of geometric shapes or forms. Width, depth, and/or other defining measurement(s) of protrusions and/or indentions may vary over its trajectory and/or may vary with respect to other protrusions and/or indentions that are formed on the inner or outer surfaces of the kettle 106.

FIG. 4 is a planar view of an example shaped surface 400 that is corrugated according to an example pattern. In various embodiments, all or a portion of the base inner surface 304, the base outer surface 302, the wall inner surface 308, an/or the wall outer surface 306, may be shaped according to at least a portion of the shaped surface 400 shown in FIG. 4.

The shaped surface 400 includes a plurality of ridges 402-1 . . . 402-n (hereinafter referred to as “ridges 402”) and furrows 404-1 . . . 404-n (hereinafter referred to as “furrows 404”). By including ridges 402 and furrows 404, the surface area of the shaped surface 400 is increased over a surface area of a flat surface of the same size as the shaped surface 400.

One or more of the ridges 402 may include portions that extend from the surface and one or more of the furrows 404 may be the lowest portion (e.g., at the bottom or in the surface such as an indentation) of the shaped surface 400. In some embodiments, the shaped surface 400 has a surface area that is at least two times greater than if the shaped surface 400 was flat. In some embodiments, the shaped surface 400 has a surface area that is at least three times greater than if the bottom of the kettle 100 was flat. In another example, the shaped surface 400 has a surface area that is at least 1.2 times greater or more than if the bottom of the kettle was flat. In some embodiments, the ridges 402 and the furrows 404, in the example pattern shown in FIG. 4, are parallel to each other. In various embodiments, all or some of the ridges 402 and the furrows 404 may, or may not, be parallel to each other.

In some embodiments, adjacent ridges 402 and furrows 404 are shaped as a sinusoidal wave. In being shaped as a sinusoidal wave, ridge sides of the ridges 402 are curved towards ridge top planes at the top of the ridges 402. The ridge top plane is a hypothetical flat surface which contains the top of each ridge 402. For example, the ridge top plane may be a tangential plane containing the peak (e.g., highest amplitude value) point of all, some, or most ridges 402. In some embodiments, the period, amplitude, phase angle, and/or symmetry of different portions of any number of sinusoidal waves may vary.

Additionally, in being shaped as a sinusoidal wave, furrow sides of the furrows 404 are curved towards furrow top planes at the bottom of the furrows 404. The furrow top plane is a hypothetical flat surface which contains the bottom of each furrow 404. For example, the furrow top plane may be a tangential plane containing the trough (e.g., lowest amplitude value) point of all, some, or most furrows 404.

In some embodiments, adjacent ridges 402 and furrows 404 are shaped as a square wave. In being shaped as a square wave, the top portion of each of the ridges 402 (e.g., highest amplitude value) may be in a tangential plane (e.g., a ridge top plane). Similarly, bottom portions of each of the furrows 404 (e.g., lowest amplitude value) may be in a tangential plane (e.g., a furrow top plane). In various embodiments, symmetry of any or all of the square waves may vary.

In various embodiments, regardless if the shaped portion is sinusoidal, is rectangular wave shaped, includes posts, includes indentions, and/or the like, one, some, or all of the shaped portions (e.g., ridges 402) may have different heights (e.g., may have different highest amplitude values) whereby not all of the peaks (e.g., top portions) of the shaped portions may be in a plane. Similarly, one, some, or all of the shaped portions (e.g., furrows 404) may have different troughs (e.g., may have different lowest amplitude values) whereby not all of the lowest point of the shaped portions may be in a plane. In various embodiments, symmetry of all or a portion of any or all of the posts and/or indentations may vary.

Although FIG. 4 depicts eighteen (18) parallel shaped portions 400, there may be any number of shaped portions that may be parallel, partially parallel, or not parallel. Those skilled in the art will appreciate that there may be any number of shaped portions 400 (including high portions and low portions of any shape or combination of shapes).

FIG. 5 is a planar view of an example shaped surface 500 that is corrugated according to another example pattern. In various embodiments, an applicable combination of all or a portion of a base inner surface, and all or a portion of a base outer surface may be shaped according to the shaped surface 500 shown in FIG. 5.

The shaped surface 500 includes a plurality of ridges 502-1 . . . 502-n (hereinafter referred to as “ridges 502”) and furrows 504-1 . . . 504-n (hereinafter referred to as “furrows 504”). In including ridges 502 and furrows 504, the surface area of the shaped surface 500 is increased over a surface area of a flat surface of the same size as the shaped surface 500. In some embodiments, the shaped surface 500 has a surface area that can be at least two times or greater than if the shaped surface 500 was flat. In another embodiment, the shaped surface 500 has a surface area that can be at least three times or greater than if the shaped surface 500 was flat. In another example, the shaped surface 500 has a surface area that can be at least 1.2 times or greater than if the shaped surface 500 was flat.

The ridges 502 and the furrows 504 are arranged adjacent to each other concentrically about a center 506 of the shaped surface 500. The center 506 can be a center of the base outer surface or the center of a base inner surface depending on which surface of the base is patterned according to the shaped surface 500 shown in FIG. 5.

In some embodiments, the ridges 502 and the furrows 504 can be shaped as a sinusoidal wave, as discussed with respect to FIG. 4. In another embodiment, the ridges 502 and the furrows 504 can be shaped as a square wave, as discussed above with respect to FIG. 4.

Although FIG. 5 depicts ten (10) concentric circles, there may be any number of concentric circles or partially concentric circles. Those skilled in the art will appreciate that there may be any number of shaped portions (including high portions and low portions of any shape or combination of shapes).

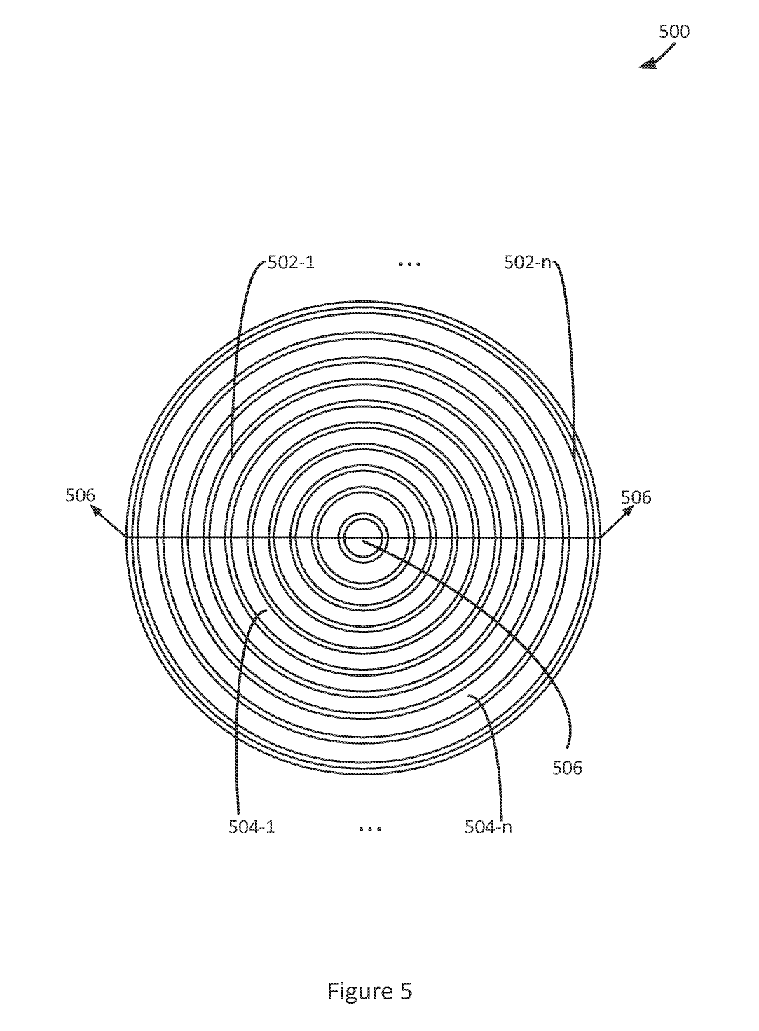

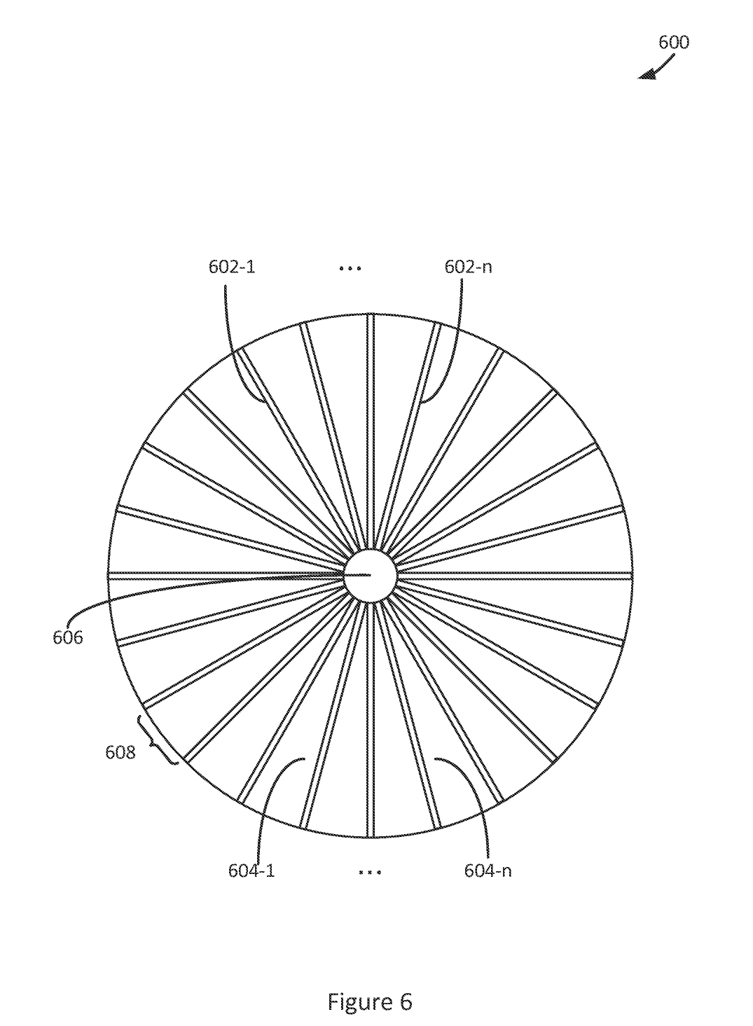

FIG. 6 is a planar view of an example shaped surface 600 that is corrugated according to another example pattern. In various embodiments, an applicable combination of all or a portion of a base inner surface and/or all or a portion of a base outer surface may be shaped according to the shaped surface 600 shown in FIG. 6.

The shaped surface 600 includes a plurality of ridges 602-1 . . . 602-n (hereinafter referred to as “ridges 602”) and furrows 604-1 . . . 604-n (hereinafter referred to as “furrows 604”). In including ridges 602 and furrows 604, the surface area of the shaped surface 600 is increased over a surface area of a flat surface of the same size as the shaped surface 600. In some embodiments, the shaped surface 600 has a surface area that can be at least two times or greater than if the shaped surface 600 was flat. In another embodiment, the shaped surface 600 has a surface area that can be at least three times or greater than if the shaped surface 600 was flat. The ridges 602 and the furrows 604 radiate out from a center 606. The center 606 can be the center, or originate at one or more points distant from the center, of the base outer surface or the center of a base inner surface depending on which surface of the base is patterned according to the shaped surface 600 shown in FIG. 6. In the pattern shown in FIG. 6 the furrows 604 increase in furrow width 608 as the furrow extends out from the center 606. In other embodiments, a ridge width of a ridge can increase as the ridge extends out from the center 606.

In various embodiments, different patterns may include different pattern centers any of which may be different than a center of a bottom surface (e.g., center 606 in FIG. 6). For example, a bottom outer surface 302 may include any number of rings located next to each other, each ring including its own center. Any number of shaped surfaces may be oriented in any manner. As a result, each pattern and/or combination of patterns of shaped surface may be oriented around any number of pattern centers.

In some embodiments, the ridges 602 and furrows 604 can be shaped as a sinusoidal wave, as discussed with respect to FIG. 4. In various embodiments, the ridges 602 and furrows 604 may be shaped as half circles. In another embodiment, the ridges 602 and the furrows 604 can be shaped as a square wave, as discussed with respect to FIG. 4.

Although FIG. 6 depicts twenty four (24) shaped portions radiating from a center, there may be any number of shaped portions radiating form the center. Those skilled in the art will appreciate that there may be any number of shaped portions (including high portions and low portions of any shape or combination of shapes).

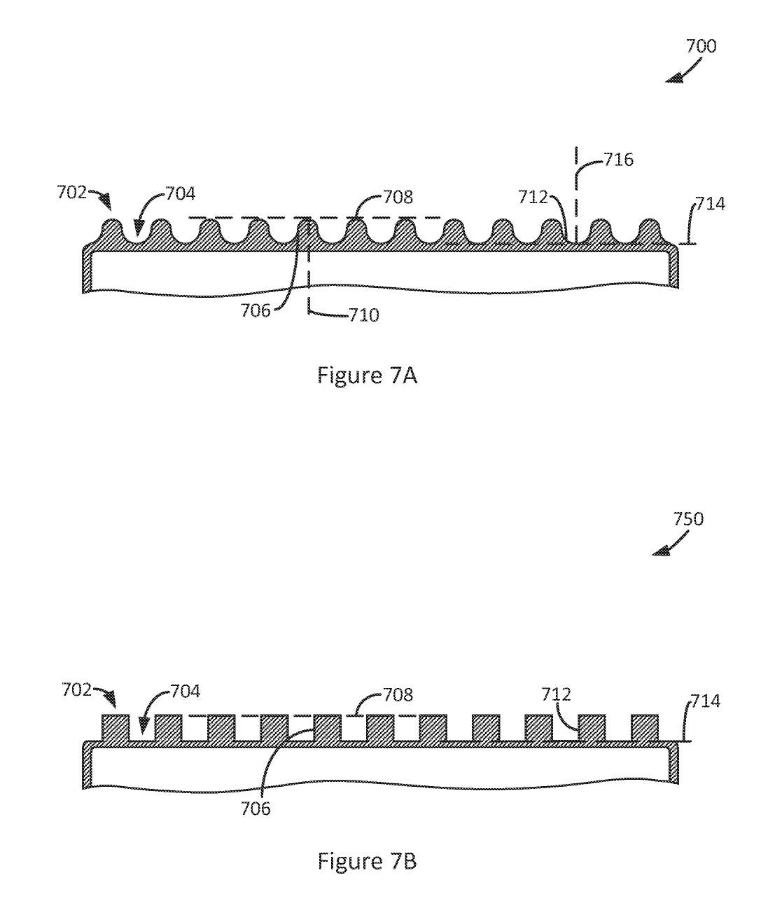

FIG. 7A is a cross-sectional view of a shaped surface 700 that includes ridges 702 and furrows 704 shaped according to a sinusoidal wave. The shaped surface 700 shown in FIG. 7A can be formed in accordance with the example patterns shown in FIGS. 4-6. The shaped surface 700 can be formed on any combination of a base inner surface, a base outer surface, a wall inner surface, and a wall outer surface. In some embodiments, the shaped surface 700 shown in FIG. 7A has at least 2 times greater surface area (e.g., at least 2.3 times greater surface area) than the surface area of a flat surface.

The ridges 702 include ridge sides 706 that are curved towards a ridge top plane 708 (e.g., a plane tangent to the peaks of the sinusoidal waves). In an embodiment, the ridges 702 can be shaped such that a cross section of a ridge of the ridges 702 exhibits reflection symmetry about a ridge axis of symmetry 710 that is normal to the ridge top plane 708.

The furrows 704 include furrow sides 712 that are curved towards a furrow bottom plane 714 (e.g., a plane tangent to the troughs of the sinusoidal waves). In an embodiment, the furrows 704 can be shaped such that a cross section of a furrow of the furrows 704 exhibits reflection symmetry about a furrow axis of symmetry 716 that is normal to the furrow bottom plane 714.

An example function of heat transfer is as follows, where “U” is the heat transfer coefficient, “Area” is the area for which the heat is transferred to the substance, and “ΔT” is the difference in temperature (e.g., between a solid surface such as a portion of the kettle 100 and a contained liquid):

Q=(U)(Area)(ΔT)

Here, “Q” has units of energy per time (e.g., Joule per second).

In various embodiments, an arc length for a sinusoidal wave is defined as follows. Assuming the sinusoidal wave includes component a, where a=peak amplitude (measured from the zero crossings) and 2π/b=period of the sinusoidal wave:

$$y = a sin bx$$

$$\frac{d y}{d x} = ab cos bx$$

$$\begin{matrix}Arc length = S \\ = 2 {\int }_{0}^{\frac{π}{b}} \sqrt{1 + {( \frac{d y}{d x} )}^{2}} d x \\ = S \\ = 2 {\int }_{0}^{\frac{π}{b}} \sqrt{1 + {a}^{2} {b}^{2} {cos}^{2} ( bx )} d x\end{matrix}$$

Assuming a=π and b=1 then:

S=2∫₀^{π}\sqrt{1+π² cos²(x)}dx

S=2(7.21403)=14.482

Assuming unit width, the area equals (S)(1) or S.

FIG. 7B is a cross-sectional view of a shaped surface 750 that is corrugated with ridges 702 and furrows 704 shaped according to a square wave. The shaped surface 750 shown in FIG. 7B can be formed in accordance with the example patterns shown in FIGS. 4-6. The shaped surface 750 can be formed on any combination of a base inner surface, a base outer surface, a wall inner surface, and a wall outer surface. In some embodiments the shaped surface 750 shown in FIG. 7B has at least 3 times greater surface area than a surface area of a flat surface.

The ridges 702 include planar tops that form the tops of the ridges 702. The ridges 702 include ridge sides 706 that extend linearly upwards towards a ridge top plane 708. The ridge top plane 708 is formed along a planar top of a ridge with a corresponding ridge side 706 that extends linearly upwards towards the ridge top plane 708.

The furrows 704 include planar bottom that form the bottoms of the furrows 704. The furrows 704 include furrow sides 712 that extend linearly downwards towards a furrow bottom plane 714. The furrow bottom plane 714 is formed along a planar bottom of a furrow with a corresponding furrow side 712 that extends linearly downward towards the furrow bottom plane 714.

In various embodiments, a rectangular wave pattern is as follows. Assuming the rectangular wave includes component a where a is the peak amplitude (e.g., the height measured from the zero crossings) and b is the width of a rectangular wave (e.g., as measured along the zero crossings):

S=4a+2b

If a=b=π, S=4π+2π=6π=18.85

Relative to a flat surface with length

2b=2π=6.2832

Assuming unit width, the area equals (S)(1) or S.
For example:

| | Area (Assuming | Area Relative to |
|---|---|---|
| Surface | Unit Width) | a Flat Surface |
| Flat | 6.2832 | 1.000 |
| Sinusoidal in one dimension | 14.482 | 2.305 |
| with amplitude defined above | | |
| equal to half of the period | | |
| Rectangular in one dimension | 18.85 | 3.000 |
| with amplitude defined above | | |
| equal to half of the period | | |

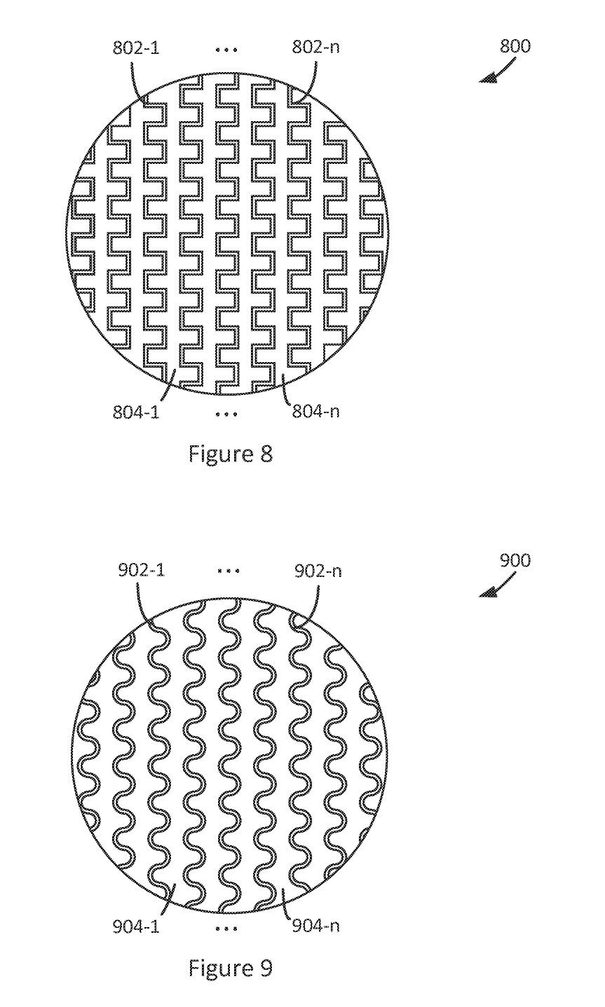

FIG. 8 is a planar view of a shaped surface 800 that is corrugated according to another example pattern. In various embodiments, an applicable combination of a portion of a base inner surface, a base outer surface, a wall inner surface, and a wall outer surface may be shaped according to the shaped surface 800 shown in FIG. 8.

The shaped surface 800 includes a plurality of ridges 802-1 . . . 802-n (hereinafter referred to as “ridges 802”) and furrows 804-1 . . . 804-n (hereinafter referred to as “furrows 804”). By including ridges 802 and furrows 804, the surface area of the shaped surface 800 is increased over a surface area of a flat surface of a same size as the shaped surface 800. In some embodiments, the shaped surface 800 has a surface area that is at least two times greater than if the shaped surface 800 was flat. In another embodiment, the shaped surface 800 has a surface area that is at least three times greater than if the shaped surface 800 was flat. The ridges 802 are shaped along the longitudinal length of the ridges 802 according to a planar square wave pattern. Similarly, the furrows 804 are shaped along the longitudinal length of the furrows according to an inverse of a planar square wave pattern of which the ridges 802 adjacent to the furrows 804 are shaped.

FIG. 9 is a planar view of a shaped surface 900 that is corrugated according to another example pattern. In various embodiments, an applicable combination of a portion of a base inner surface, a base outer surface, a wall inner surface, and a wall outer surface may be shaped according to the shaped surface 900 shown in FIG. 9.

The shaped surface 900 includes a plurality of ridges 902-1 . . . 902-n (hereinafter referred to as “ridges 902”) and furrows 904-1 . . . 904-n (hereinafter referred to as “furrows 904”). In including ridges 902 and furrows 904, the surface area of the shaped surface 900 is increased over a surface area of a flat surface of a same size as the shaped surface 900. In some embodiments, the shaped surface 900 has a surface area that is at least two times greater than if the shaped surface 900 was flat. In another embodiment, the shaped surface 900 has a surface area that is at least three times greater than if the shaped surface 900 was flat. The ridges 902 are shaped along the longitudinal length of the ridges 902 according to a planar sinusoidal pattern. Similarly, the furrows 904 are shaped along the longitudinal length of the furrows according to an inverse of a planar sinusoidal wave pattern of which the ridges 902 adjacent to the furrows 904 are shaped.

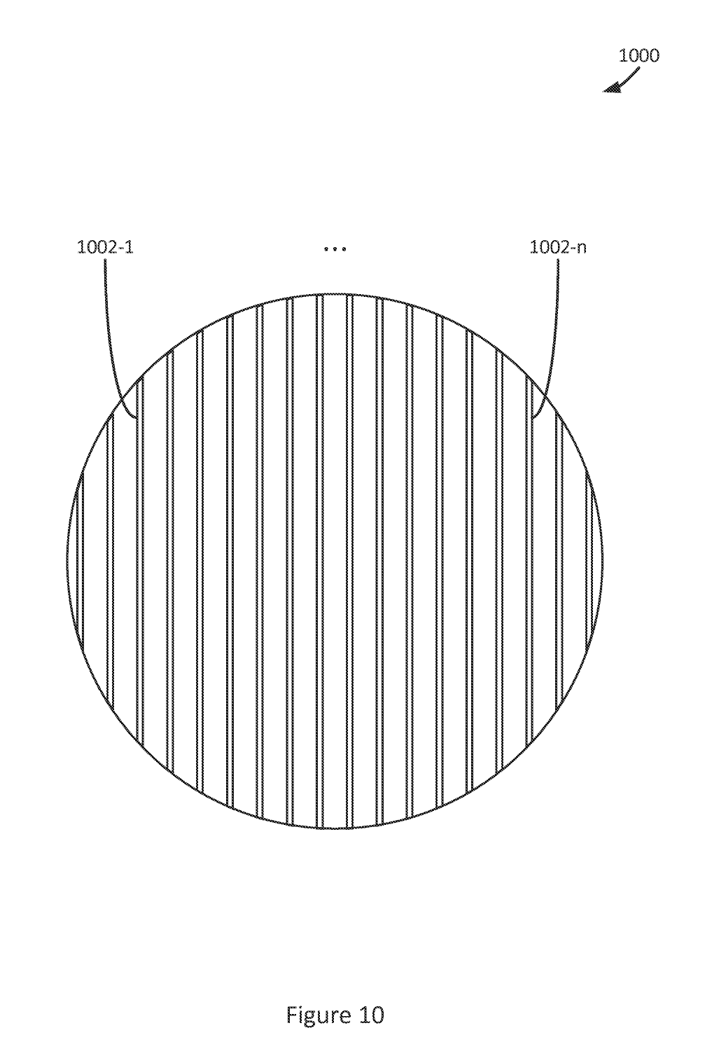

FIG. 10 is a planar view of a shaped surface 1000 with a plurality of protrusions according to a protrusion pattern. In various embodiments, protrusions included in the protrusion pattern of the shaped surface shown in FIG. 10 can include any combination of square shaped protrusions, trapezoid shaped protrusions, triangular shaped protrusions, sinusoidal shaped protrusions, and/or protrusions of any shape or pattern.

The protrusion pattern shown in FIG. 10 includes protrusion lines 1002-1 . . . 1002-n (hereinafter referred to as “protrusion lines 1002”), in which protrusions are formed to increase the surface area of the shaped surface 1000. In the shaped surface shown in FIG. 10, the protrusion lines 1002 are parallel to each other.

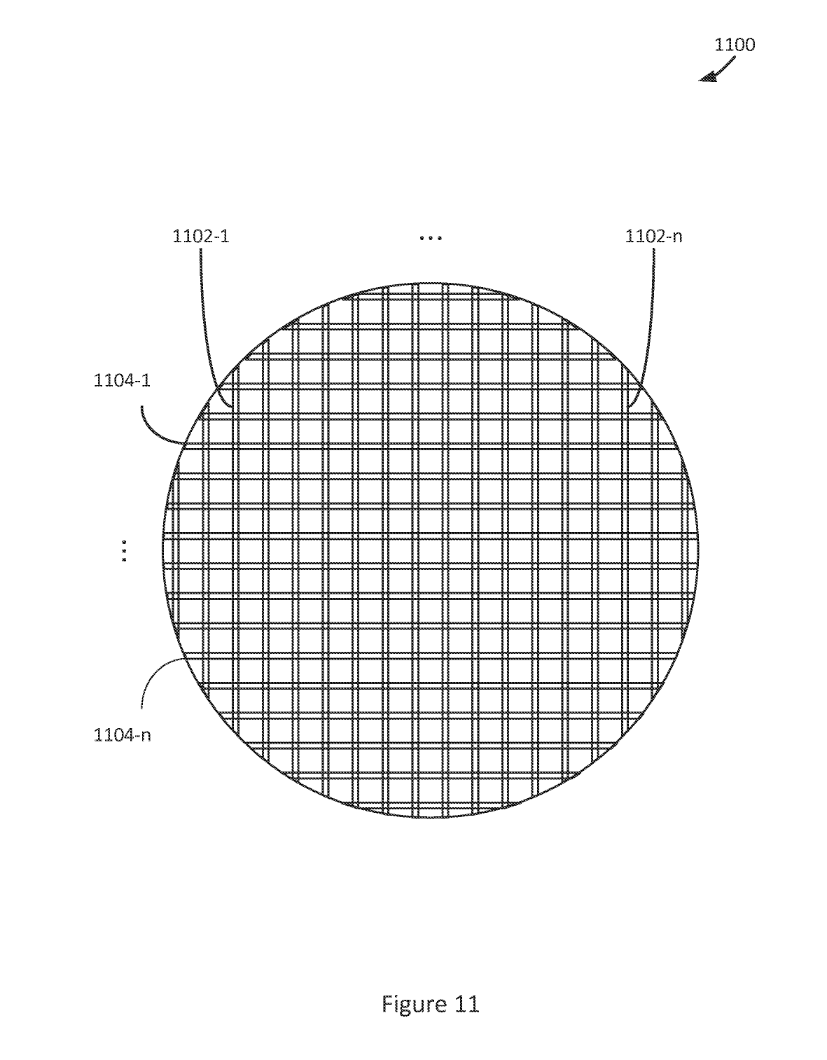

FIG. 11 is a planar view of a shaped surface 1100 with a plurality or protrusions according to another protrusion pattern. In various embodiments, protrusions included in the protrusion pattern of the shaped surface shown in FIG. 11 can include any combination of square shaped protrusions, trapezoid shaped protrusions, sinusoidal shaped protrusions, and/or protrusions of any shape or pattern.

The protrusion pattern shown in FIG. 11 includes protrusion columns 1102-1 . . . 1102-n (hereinafter referred to as “protrusion columns 1102”) and protrusion rows 1104-1 . . . 1104-n (hereinafter referred to as “protrusion rows 1104”). Protrusions are formed within the protrusion columns 1102 and the protrusion rows 1104 to increase the surface area of the shaped surface 1100. The protrusion columns 1102 and the protrusion rows 1104 intersect to form an array of protrusions on the shaped surface 1100.

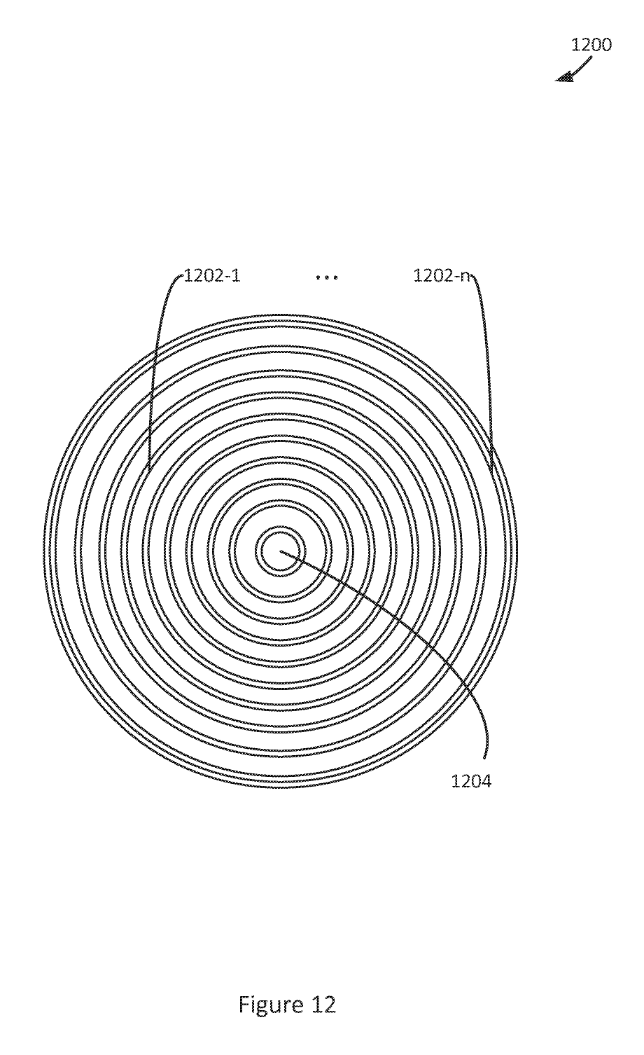

FIG. 12 is a planar view of a shaped surface 1200 with a plurality or protrusions according to another protrusion pattern. In various embodiments, protrusions included in the protrusion pattern of the shaped surface shown in FIG. 12 can include any combination of square shaped protrusions, trapezoid shaped protrusions, sinusoidal shaped protrusions, and/or protrusions of any shape or pattern.

The protrusion pattern shown in FIG. 12 includes protrusion rings 1202-1 . . . 1202-n (hereinafter referred to as “protrusion rings 1202”) concentrically formed about a center 1204 of the shaped surface 1200. The center 1204 can be a center of the base outer surface or the center of a base inner surface depending on which surface of the base is patterned according to the shaped surface 1200 shown in FIG. 12. Protrusions are formed within the protrusion rings 1202 to increase the surface area of the shaped surface 1200.

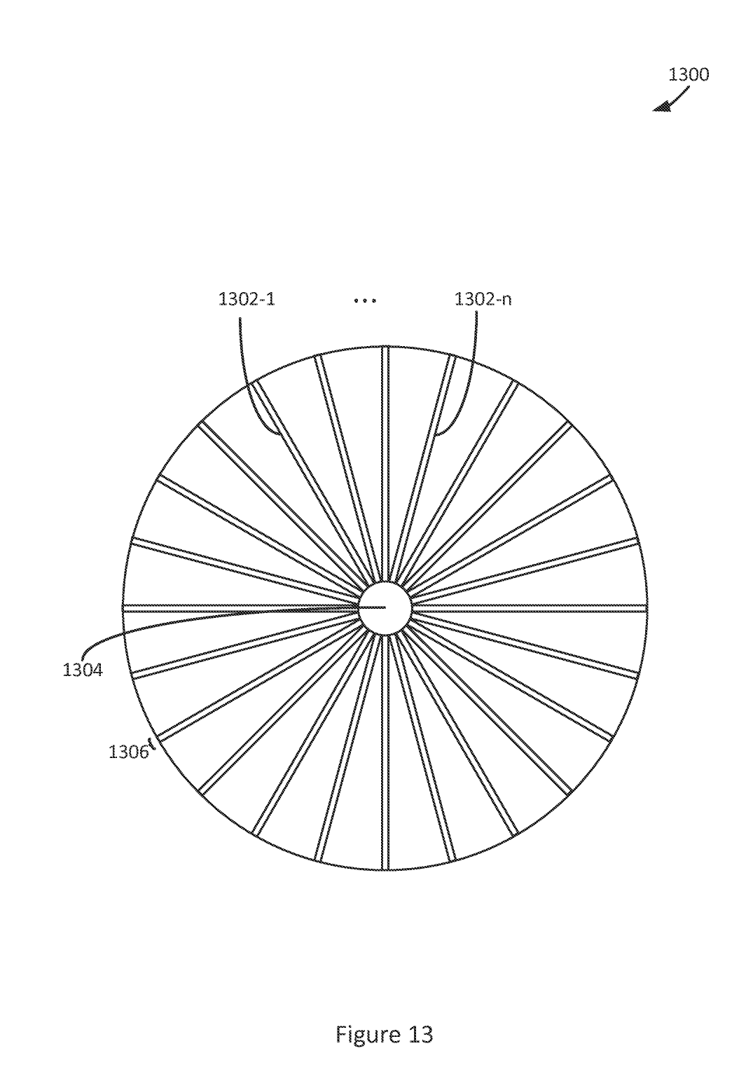

FIG. 13 is a planar view of a shaped surface 1300 with a plurality or protrusions according to another protrusion pattern. In various embodiments, protrusions included in the protrusion pattern of the shaped surface shown in FIG. 13 can include any combination of square shaped protrusions, trapezoid shaped protrusions, sinusoidal shaped protrusions, and/or protrusions of any shape or pattern.

The protrusion pattern shown in FIG. 13 includes protrusion radials 1302-1 . . . 1302-n (hereinafter referred to as “protrusion radials 1302”) formed to radiate out from a center 1304, center area, or other focal points or areas, of the shaped surface 1300. The center 1304 can be a center of the base outer surface or the center of a base inner surface depending on which surface of the base is patterned according to the shaped surface 1300 shown in FIG. 13. Protrusions are formed within the protrusion radials 1302 to increase the surface area of the shaped surface 1300. The protrusion radials 1302 have protrusion radial widths 1306 that can be constant across the length of the protrusion radials 1302, or they can change across the length of the protrusion radials 1302. For example, protrusion radial widths 1306 of the protrusion radials 1302 can increase across the length of the protrusion radials 1302 as the protrusion radials 1302 extend out from the center 1304.

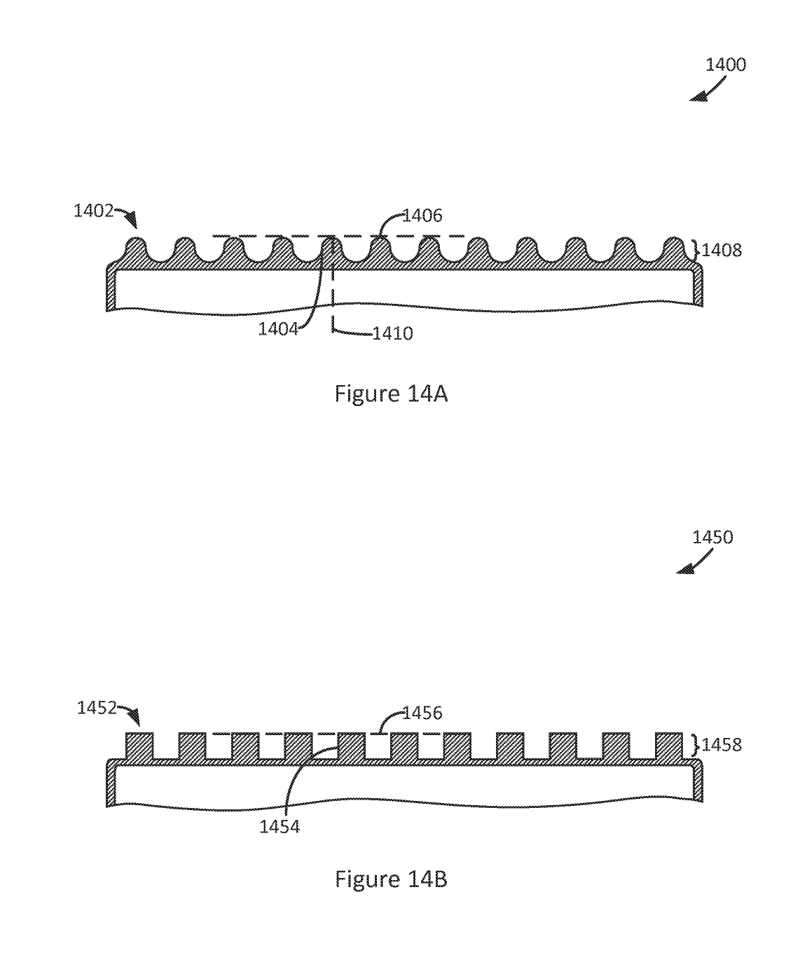

FIG. 14A is a cross-sectional view of a shaped surface 1400 with protrusions 1402 shaped as a sinusoidal wave. In various embodiments, the protrusions 1402 shown in FIG. 14A can be arranged in the protrusion patterns shown in FIGS. 10-13.

In being shaped as a sinusoidal wave, the protrusions 1402 have protrusion sides 1404 that curve upwards towards a protrusion plane 1406. The protrusion plane 1406 is a plane formed across the tops (e.g., peaks) of the protrusions 1402 at a protrusion height 1408 of the protrusions 1402. In the shaped surface 1400 shown in FIG. 14A, the protrusions 1402 all have the same protrusion height 1408. The protrusion cross-section of the protrusions 1402 exhibit reflection symmetry about a protrusion axis of symmetry 1410 normal to the protrusion plane 1406.

FIG. 14B is a cross-sectional view of a shaped surface 1450 with protrusions 1452 shaped as a square wave. In various embodiments, the protrusions 1452 shown in FIG. 14B can be arranged in the protrusion patterns shown in FIGS. 10-13.

In being shaped as a square wave, the protrusions 1452 have protrusion sides 1454 that extend upwards towards a protrusion plane 1456. The protrusion plane 1456 is a plane formed across the top portions (e.g., peaks) of the protrusions 1452 at a protrusion height 1458 of the protrusions 1452. In the shaped surface 1450 shown in FIG. 14B, the protrusions 1452 all have the same protrusion height 1458.

The shaped portions (e.g., protrusions and/or indentions) may comprise any material or the like including, but not limited to alloys, ceramics, metals, or combination of materials. In some embodiments, shaped portions may include a sandwich structure of various layers of materials. In various embodiments, any or all of the shaped portions are of the same material as all or a part of the base of a vessel. In some embodiments, any or all of the shaped portions are of a different material as all or a part of the base of a vessel.

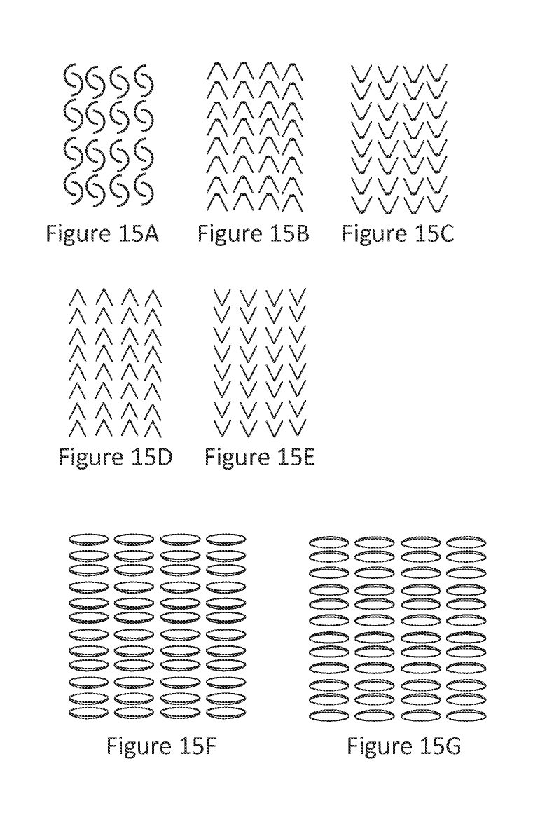

FIGS. 15A-G depict a variety of different protrusions and/or indentations that may be on the outer base of a vessel, inside the vessel, or on both the outer base and inside the vessel (e.g., base inner surface and base outer surface). In some embodiments, there may be any combination of one or more different shapes (e.g., one or more in any combination of protrusions and/or indentations). For example, a bottom of a vessel may include conical protrusions as well as conical or triangular indentations in the bottom of the vessel.

FIG. 15A depict interlocking elbow shaped surfaces in some embodiments. The interlocking elbow shaped surfaces may project outward from the base of the kettle (or inside the kettle). In some embodiments, the elbow shaped surfaces may project inward (forming an indentation) from the base of the kettle (or inside the kettle). A kettle may include both projections and indentations. Those skilled in the art will appreciate that any shapes or combination of shapes may be used for protrusions and/or indentations.

FIG. 15B depicts conical shaped protrusions in some embodiments. FIG. 15C depicts conical shaped indentations in some embodiments. FIG. 15D depicts triangular shaped protrusions in some embodiments. FIG. 15E depicts triangular shaped indentations in some embodiments. FIG. 15F depicts dimple shaped indentation in some embodiments. FIG. 15G depicts dimple shaped protrusions in some embodiments.

Although the shaped protrusions and indentations in FIG. 15B-G appear to be the same, size, height, symmetry, or the like, they may be different for any number of the shaped protrusions and/or shaped indentations. Further, there may be any amount of space between the shaped protrusions and/or indentations. Moreover, although the protrusions and/or indentations appear to be right next to each other, the protrusions and/or indentations may be spaced in any way and in any pattern.

The present invention is described above with reference to exemplary embodiments. It will be apparent to those skilled in the art that various modifications may be made and other embodiments can be used without departing from the broader scope of the present invention. Therefore, these and other variations upon the exemplary embodiments are intended to be covered by the present invention.

1. An article of manufacture comprising:
a wall portion having a wall inner surface and a wall outer surface;
a base portion having a base inner surface and a base outer surface, at least a portion of the wall portion and the base portion forming a vessel with a single cavity to freely mix a fluid solid mixture comprising a liquid and a solid therein, the single cavity not containing a thermodynamic barrier, at least a heating surface portion of the base outer surface positioned to receive heat from a heating source, and
a shaped portion of the base inner surface shaped to have substantially more surface area in thermal contact with the fluid solid mixture than a flat base inner surface to transfer additional heat from the heat source throughout the fluid solid mixture in the single cavity.

2. The article of manufacture of claim 1, wherein the shaped portion of the base inner surface is corrugated to include a plurality of ridges and furrows.

3. The article of manufacture of claim 2, wherein the plurality of ridges and furrows are shaped as a sinusoidal wave, such that ridge sides of the plurality of ridges are curved towards ridge top planes of the ridges and furrow sides of the plurality of furrows are curved towards furrow bottom planes of the furrows.

4. The article of manufacture of claim 3, wherein at least one of:
a ridge of the plurality of ridges is shaped such that a ridge cross section of the ridge exhibits reflection symmetry about a ridge axis of symmetry normal to a ridge top plane of the ridge;
or, a furrow of the plurality of furrows is shaped such that a furrow cross section of the furrow exhibits reflection symmetry about a furrow axis of symmetry normal to the furrow bottom plane of the furrows.

5. The article of manufacture of claim 2, wherein the plurality of ridges and furrows are shaped as a square wave, such that ridge sides of the plurality of ridges extend up to a ridge top plane of a ridge that extends across a top of the ridge, and furrow sides of the plurality of furrows extend down to a furrow bottom plane of a furrow that extends across a bottom of the furrows.

6. The article of manufacture of claim 2, wherein the plurality of ridges and furrows of the shaped portion of at least one of the base outer surface or the base inner surface are concentrically positioned about a corresponding center of the base outer surface or the base inner surface.

7. The article of manufacture of claim 2, wherein the plurality of ridges and furrows of the shaped portion of at least one of the base outer surface or the base inner surface radiate out from a corresponding center of the base outer surface or the base inner surface.

8. The article of manufacture of claim 2, wherein the plurality of ridges and furrows of the shaped portion are parallel to each other.

9. The article of manufacture of claim 2, wherein at least one of the plurality of ridges or furrows radiates out from a center of the base portion at an increasing width.

10. The article of manufacture of claim 2, wherein the shaped portion of the base inner surface includes a plurality of protrusions to cause the corresponding base inner surface to have substantially more surface area than a corresponding flat base inner surface.

11. The article of manufacture of claim 10, wherein protrusions of the plurality of protrusions have a same protrusion height.

12. The article of manufacture of claim 10, wherein the plurality of protrusions are positioned in the corresponding base outer surface or the base inner surface in an array that includes a plurality of protrusion rows and protrusion columns.

13. The article of manufacture of claim 12, wherein protrusions of the plurality of protrusions within at least one of a protrusion row of the plurality of protrusion rows or a protrusion column of the plurality of protrusion columns are shaped as a sinusoidal wave, such that protrusion sides of the protrusions within at least one of the protrusion row or the protrusion column curve upward towards a protrusion plane at a protrusion height.

14. The article of manufacture of claim 13, wherein the protrusions of the plurality of protrusions exhibit reflection symmetry about a protrusion axis of symmetry normal to the protrusion plane.

15. The article of manufacture of claim 12, wherein protrusions of the plurality of protrusions within at least one of a protrusion row of the plurality of protrusion rows or a protrusion column of the plurality of protrusion columns are shaped as a square wave, such that protrusion sides of the protrusions within at least one of the protrusion row or the protrusion column extend upward towards a protrusion top plane, the protrusion top plane extending across protrusion tops of the protrusions within at least one of the protrusion row or the protrusion column.

16. The article of manufacture of claim 10, wherein the plurality of protrusions are positioned in the corresponding base outer surface or the base inner surface in protrusion rings that are concentrically positioned about a corresponding center of the base outer surface or the base inner surface.

17. The article of manufacture of claim 10, wherein the plurality of protrusions are positioned in the corresponding base outer surface or the base inner surface in protrusion radials that radiate out from a corresponding center of the base outer surface or the base inner surface.

18. The article of manufacture of claim 1, wherein the article of manufacture is a kettle, pot, or pan.

19. The article of manufacture of claim 1, wherein the shaped portion of the base inner surface being shaped to have 1.2 or more times the surface area than the corresponding flat base inner surface.

20. The article of manufacture of claim 2, wherein the shaped portion of the base inner surface includes a plurality of indentations to cause the corresponding base inner surface to have substantially more surface area than the corresponding flat base inner surface.

21. The article of manufacture of claim 10, wherein indentations of the plurality of protrusions have a same indentation height.

22. The article of manufacture of claim 10, wherein the plurality of indentations are positioned in the corresponding base outer surface or the base inner surface in an array that includes a plurality of indentations rows and indentations columns.

23. (canceled)

24. An article of manufacture comprising:
a wall portion having a wall inner surface and a wall outer surface;
a base portion having a base inner surface and a base outer surface, at least a portion of the wall portion and the base portion forming a vessel with a single cavity to freely mix a fluid solid mixture comprising a liquid and a solid therein, the single cavity not containing a thermodynamic barrier, at least a heating surface portion of the base outer surface positioned to receive heat from a heating source, and
a shaped portion of the base inner surface shaped to have protrusions allowing substantially more surface area in thermal contact with the fluid solid mixture than a flat base inner surface to transfer additional heat from the heat source throughout the fluid solid mixture in the single cavity.

25. An article of manufacture comprising:
a wall portion having a wall inner surface and a wall outer surface;
a base portion having a base inner surface and a base outer surface, at least a portion of the wall portion and the base portion forming a vessel with a single cavity to freely mix a fluid solid mixture comprising a liquid and a solid therein, the single cavity not containing a thermodynamic barrier, at least a heating surface portion of the base outer surface positioned to receive heat from a heating source, and
a shaped portion of the base inner surface shaped to have indentations allowing substantially more surface area in thermal contact with the fluid solid mixture than a flat base inner surface to transfer additional heat from the heat source throughout the fluid solid mixture in the single cavity.

26. The article of manufacture of claim 1, further comprising a shaped portion of the base outer surface being shaped to have substantially more surface area in thermal contact with the heating source than a flat base outer surface to receive additional heat from the heating source.

27. The article of manufacture of claim 24, further comprising a shaped portion of the base outer surface being shaped to have indentations allowing substantially more surface area in thermal contact with the heating source than a flat base outer surface to receive additional heat from the heating source.

28. The article of manufacture of claim 25, further comprising a shaped portion of the base outer surface being shaped to have protrusions allowing substantially more surface area in thermal contact with the heating source than a flat base outer surface to receive additional heat from the heating source.

29. The article of manufacture of claim 1, wherein material of the base inner surface is different from material of the base outer surface.

30. The article of manufacture of claim 1, wherein the base outer surface and the base inner surface sandwiches a material to enhance heat transfer.
